(19) United States
(12) Patent Application Publication
(10) Pub. No.: US 2020/0191319 A1
(43) Pub. Date: Jun. 18, 2020

(54) JOINT CONFIGURATIONS FOR VACUUM-INSULATED ARTICLES

(71) Applicant: CONCEPT GROUP LLC, Wellesley, MA (US)

(72) Inventors: Aarne H. Reid, Jupiter, FL (US); David H. Reid, Jr., Fort Pierce, FL (US); Shriram RADHAKRISHNAN, West Palm Beach, FL (US)

(21) Appl. No.: 16/628,319

(22) PCT Filed: Jul. 6, 2018
(86) PCT No.: PCT/US2018/041042

§ 371 Date: Jan. 3, 2020

Related U.S. Application Data
(60) Provisional application No. 62/529,628, filed on Jul. 7, 2017.
(60) Provisional application No. 62/531,472, filed on Jul. 12, 2017.
(60) Provisional application No. 62/531,507, filed on Jul. 12, 2017.

(51) Int. Cl. F16L 59/065; F17C 3/00

(52) U.S. Cl. CPC F16L 59/065; B32B 1/00; F17C 3/00

(57) ABSTRACT

Provided are vacuum-insulated articles comprising inner and outer tubes that define an evacuated space therebetween, one or both of the inner and outer tubes optionally comprising a flared region and a joint region that define a trough into which brazing or other material can be applied to facilitate sealing the inner and outer tubes to one another.

### RELATED APPLICATIONS

The present application claims priority to and the benefit of U.S. Patent Application 62/529,628, “Joint Configurations For Vacuum-Insulated Articles” (filed Jul. 7, 2017); U.S. Patent Application 62/531,507, “Vacuum-Insulated Articles With Enhanced Rigidity for Extreme Temperature Applications” (filed Jul. 12, 2017); and U.S. Patent Application 62/531,472, “Vacuum Insulated Vessels” (filed Jul. 12, 2017). Each of the foregoing applications is incorporated herein in its entirety for any and all purposes.

### TECHNICAL FIELD

The present disclosure relates to the field of vacuum-insulated articles.

### BACKGROUND

There is a demand in a wide range of fields for well-insulated vessels, boxes, pipes, catheters, tubes, and other such material containment and transport articles. Such insulated articles allow users to transfer and/or store fluids, gases, and other materials while also maintaining the relative temperature for extended periods of time.

Although vacuum-insulated articles have favorable insulating performance, certain vacuum-insulated articles can be challenging to assemble at scale. Accordingly, there is a long-felt and ongoing need in the art for vacuum-insulated articles. The value of such articles would be enhanced if the manufacture of the articles were comparatively straightforward and scalable.

### SUMMARY

In meeting the described needs in the art, the present disclosure first provides vacuum-insulated articles, comprising: an outer tube having a proximal end and a distal end; and an inner tube having a proximal end, a distal end, and a lumen, the inner tube being disposed within the outer tube and the inner tube having a major axis of the lumen of the inner tube, the inner tube and the outer tube defining an evacuated insulating space therebetween, the inner tube comprising a outflared region having an increasing diameter along the direction of the proximal end of the inner tube, the ouflared region extending toward the proximal end of the inner tube, at least a portion of the outflared region extending beyond the proximal end of the outer tube, as measured along the major axis, the proximal end of the inner tube extending beyond the proximal end of the outer tube, as measured along the major axis, the outer tube comprising a tapered region having a decreasing diameter in the direction of the proximal end of the outer tube, the outer tube comprising a proximal joint region extending from the tapered region of the outer tube in the direction of the proximal end of the outer tube, and the proximal joint region of the outer tube overlapping a portion of the inner tube.

The present disclosure also provides methods, comprising: storing, communicating, and/or holding a fluid in the lumen of the inner tube of an article according to the present disclosure, communicating a fluid within the lumen of the inner tube of an article according to the present disclosure, or both

Further provided are methods, comprising: with (a) an inner tube comprising a proximal end, a distal end, a major axis, and a lumen, the inner tube further comprising a outflared region having an increasing diameter along the direction of the proximal end of the inner tube, the outflared region extending toward the proximal end of the inner tube, and (b) an outer tube comprising a proximal end and a distal end, the outer tube further comprising a tapered region having a decreasing diameter in the direction of the proximal end of the outer tube, the outer tube comprising a proximal joint region extending from the tapered region of the outer tube in the direction of the proximal end of the outer tube, assembling the inner and outer tube so as to dispose the inner tube within the outer tube such that at least a portion of the outflared region of the inner tube extends beyond the proximal end of the outer tube, as measured along the major axis, the proximal end of the inner tube extends beyond the proximal end of the outer tube, as measured along the major axis, and the proximal joint region of the outer tube overlaps at least a portion of the inner tube.

Without being bound to any particular theory, the disclosed configurations are well-suited to being manufactured by molding processes and/or by press-and-die processes. An an example, an outer wall can be a tube that is flared outward (or that converges inward) at only one end. An outer wall can also be a tube that flares outward at one end and converges inward at the other end. An inner wall can be a tube that is flared outward (or that converges inward) at only one end. An inner wall can also be a tube that flares outward at one end and converges inward at the other end. Again without being bound to any particular theory, the foregoing geometries facilitate removal of the wall (e.g., a tube) from the mold and/or press-die arrangement used to make the wall.

In meeting the described needs in the art, the present disclosure first provides A vacuum-insulated article, comprising: a first wall bounding an interior volume; a second wall spaced at a distance from the first wall to define an insulating space therebetween, the first and second walls provided by first and second tubes substantially concentric with each other, a vent communicating with the insulating space to provide an exit pathway for gas molecules from the space, the vent being sealable for maintaining a vacuum within the insulating space following evacuation of gas molecules through the vent, the distance between the first and second walls being variable in a portion of the insulating space adjacent the vent such that gas molecules within the insulating space are directed towards the vent by the variable-distance portion of the first and second walls during the evacuation of the insulating space, the directing of the gas molecules by the variable-distance portion of the first and second walls imparting to the gas molecules a greater probability of egress from the insulating space than ingress, at least one of the first and second walls including a portion that converges toward the other wall adjacent the vent, and wherein the distance between the walls is at a minimum adjacent the location at which the vent communicates with the insulating space; and a third wall, the third wall disposed at a distance from the second wall and the third wall provided by a third tube substantially concentric with the first and second tubes, the third tube defining a major axis, the second and third walls defining a distance therebetween; and an adhesive material disposed between the second and third walls so as to effect structural reinforcement by the third wall of the second wall.

In some embodiments, an article can define a central axis (e.g., a central axis of a lumen within two coaxial tubes). The article can include two vents that are located at different distances (e.g., measured radially) from the central axis. Without being bound to any particular theory, this configuration can enhance formation of an evacuated space between the inner and outer walls.

In another aspect, the present disclosure provides methods, the methods comprising communicating a fluid through an article according to the present disclosure.

In meeting the long-felt needs described above, the present disclosure provides vacuum-sealed containers, comprising: a circumferentially-extending, substantially U-shaped outer wall; a circumferentially-extending, substantially U-shaped inner wall, the inner wall and outer wall defining a sealed space therebetween; the outer wall including a kink portion, the kink portion extending toward the inner wall and the kink portion connecting the outer wall to a joint portion of the outer wall, the joint portion of the outer wall overlapping with a hook portion of the inner wall, the hook portion of the inner wall being connected to the inner wall by a curved portion of the inner wall, and (a) the hook portion of the inner wall being sealably joined to the kink portion of the outer wall, (b) the joint portion of the outer wall being sealably joined to the hook portion of the inner wall, or both (a) and (b).

Also provided are vacuum-sealed containers, comprising: a circumferentially-extending, substantially U-shaped outer wall; a circumferentially-extending, substantially U-shaped inner wall, the inner wall and outer wall defining a sealed space therebetween; the outer wall including a kink portion, the kink portion extending toward the inner wall and the kink portion connecting the outer wall to a joint portion of the outer wall, the joint portion of the outer wall overlapping the inner wall, a hook portion inner wall being connected to the inner wall by a curved portion of the inner wall, and (a) the hook portion of the inner wall being sealably joined to the kink portion of the outer wall, (b) the joint portion of the outer wall being sealably joined to the inner wall, or both (a) and (b).

Further provided are vacuum-insulated articles, comprising: an outer tube having a proximal end and a distal end; an inner tube having a proximal end, a distal end, and a lumen,the inner tube being disposed within the outer tube and the inner tube having a major axis of the lumen of the inner tube, the inner tube and the outer tube being defining an evacuated insulating space therebetween, the evacuated insulating space having a proximal seal and a distal seal, (a) the proximal seal optionally being formed by a proximal vent formed between the outer tube and the inner tube, (i) the proximal vent being formed at an outflared region of the inner tube or (ii) the proximal vent being formed at a converging region of the inner tube, (b) the distal seal optionally being formed by a distal vent formed between the outer tube and the inner tube, (i) the distal vent being formed at an outflared region of the inner tube or (ii) the distal vent being formed at a converging region of the inner tube, and the proximal vent being located at a proximal vent radial distance from the major axis of the lumen, the distal vent being located at a distal vent radial distance from the major axis of the lumen, the proximal vent radial distance differing from the distal vent radial distance.

Further provided are vacuum-insulated articles, comprising: an outer tube having a proximal end and a distal end; an inner tube having a proximal end, a distal end, and a lumen, the inner tube being disposed within the outer tube and the inner tube having a major axis of the lumen of the inner tube, the inner tube and the outer tube being defining an evacuated insulating space therebetween, the evacuated insulating space having a proximal seal and a distal seal, (a) the proximal seal being formed by a proximal vent formed between the outer tube and the inner tube, (b) the distal seal being formed by a distal vent formed between the outer tube and the inner tube, the proximal vent being located at a proximal vent radial distance from the major axis of the lumen, the distal vent being located at a distal vent radial distance from the major axis of the lumen, the proximal vent radial distance differing from the distal vent radial distance.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. In the drawings:

FIG. 1 provides a view of an article according to the present disclosure;

FIG. 1A provides a closer view of the encircled “A” region in FIG. 1A;

FIG. 1B provides a closer view of the encircled “B” region in FIG. 1A;

FIG. 1C provides a closer view of the encircled “C” region in FIG. 1A;

FIG. 2 provides an exterior cutaway view of an article according to the present disclosure;

FIG. 2A provides a closer view of the joint at the upper left-hand region of the article shown in FIG. 2;

FIG. 2B provides a closer view of the joint at the upper right-hand region of the article shown in FIG. 2;

FIG. 3A provides an exterior view of an article according to the present disclosure;

FIG. 3B provides a partial cutaway view of the article of FIG. 3A;

FIG. 3C provides a cutaway view of encircled region “C” in FIG. 3B.

FIG. 4A provides a cutaway view of an exemplary vessel and FIG. 4B provides a magnified view of the area circled at the upper right of FIG. 1A;

FIG. 5A provides a cutaway view of an exemplary vessel and FIG. 5B provides a magnified view of the area circled at the upper right of FIG. 5A;

FIG. 6 provides a cutaway view of an article according to the present disclosure;

FIG. 7A provides a cutaway view of an article according to the present disclosure;

FIG. 7B provides a cutaway view of an article according to the present disclosure;

FIG. 7C provides a cutaway view of an article according to the present disclosure; and

FIG. 8 provides a cutaway view of an article according to the present disclosure.

### DETAILED DESCRIPTION OF ILLUSTRATIVE EMBODIMENTS

The present disclosure can be understood more readily by reference to the following detailed description of the disclosure and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting.

Various combinations of elements of this disclosure are encompassed by this disclosure, e.g., combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

All publications mentioned herein are incorporated herein by reference to disclose and describe the methods and/or materials in connection with which the publications are cited.

Definitions

It is also to be understood that the terminology used herein is for the purpose of describing particular aspects only and is not intended to be limiting. As used in the specification and in the claims, the term “comprising” can include the embodiments “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a foam material” includes mixtures of two or more foam materials.

As used herein, the term “combination” is inclusive of blends, mixtures, alloys, reaction products, and the like.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not. For example, the phrase “additional optional additives” means that the additives can or cannot be included and the description includes aspects that include and both do not include additional additives.

Unless otherwise stated to the contrary herein, all test standards are the most recent standard in effect at the time of filing this application.

Each of the materials disclosed herein are either commercially available and/or the methods for the production thereof are known to those of skill in the art.

It is understood that the elements disclosed herein have certain functions. Disclosed herein are certain structural requirements for performing the disclosed functions and it is understood that there are a variety of structures that can perform the same function that are related to the disclosed structures, and that these structures will typically achieve the same result.

In addition, the term “comprising” should be understood as having its standard, open-ended meaning, but also as encompassing “consisting” as well. For example, a device that comprises Part A and Part B may include parts in addition to Part A and Part B, but may also be formed only from Part A and Part B.

### BACKGROUND

In one aspect, the present disclosure provides vacuum-insulated articles that comprise a first insulating space formed between two walls. An article can include a first vent communicating with the first insulating space to provide an exit pathway for gas molecules from the first insulating space, the first vent being sealable for maintaining a first vacuum within the first insulating space following evacuation of gas molecules through the first vent; and a first seal sealing the first insulating space at the first vent.

The insulating space can be evacuated, e.g., a vacuum space. Some exemplary vacuum-insulated structures (and related techniques for forming and using such structures) can be found in United States published patent applications 2015/0110548, 2014/0090737, 2012/0090817, 2011/0264084, 2008/0121642, and 2005/0211711, all by A. Reid, and all incorporated herein by reference in their entireties for any and all purposes.

As explained in U.S. Pat. Nos. 7,681,299 and 7,374,063 (incorporated herein by reference in their entireties for any and all purposes), the geometry of the insulating space can be such that it guides gas molecules within the space toward a vent or other exit from the space. The width of the vacuum insulating space need not be not uniform throughout the length of the space. The space can include an angled portion such that one surface that defines the space converges toward another surface that defines the space. As a result, the distance separating the surfaces can vary adjacent the vent such the distance is at a minimum adjacent the location at which the vent communicates with the vacuum space. The interaction between gas molecules and the variable-distance portion during conditions of low molecule concentration serves to direct the gas molecules toward the vent.

The molecule-guiding geometry of the space provides the potential for a deeper vacuum to be sealed within the space than that which is imposed on the exterior of the structure to evacuate the space. This somewhat counterintuitive result of deeper vacuum within the space is achieved because the geometry of the present invention significantly increases the probability that a gas molecule will leave the space rather than enter. In effect, the geometry of the insulating space functions like a check valve to facilitate free passage of gas molecules in one direction (via the exit pathway defined by vent) while blocking passage in the opposite direction. It should be understood that a user can create a vacuum within the insulating space that is greater/deeper than the vacuum within the system (e.g., a vacuum chamber or vacuum furnace) that is used to give rise to the insulating space. Without being bound to any particular theory, the geometry of the insulating space can give rise to an ultimate within the insulating space that is greater/deeper than the vacuum within the vacuum furnace or vacuum chamber in which the insulating space is formed.

Another benefit associated with the deeper vacuums provided by the geometry of insulating space is that it is achievable without the need for a getter material within the evacuated space. The ability to develop such deep vacuums without a getter material provides for deeper vacuums in devices of miniature scale and devices having insulating spaces of narrow width where space constraints would limit the use of a getter material.

Other vacuum-enhancing features can also be included, such as low-emissivity coatings on the surfaces that define the vacuum space; one can also use high-reflectance coatings. The reflective surfaces of such coatings, generally known in the art, tend to reflect heat-transferring rays of radiant energy. Limiting passage of the radiant energy through the coated surface enhances the insulating effect of the vacuum space.

In some embodiments, an article can comprise first and second walls spaced at a distance to define an insulating space therebetween and a vent communicating with the insulating space to provide an exit pathway for gas molecules from the insulating space. The vent is sealable for maintaining a vacuum within the insulating space following evacuation of gas molecules through the vent. The distance between the first and second walls is variable in a portion of the insulating space adjacent the vent such that gas molecules within the insulating space are directed towards the vent during evacuation of the insulating space. The direction of the gas molecules towards the vent imparts to the gas molecules a greater probability of egress than ingress with respect to the insulating space, thereby providing a deeper vacuum without requiring a getter material in the insulating space.

The construction of structures having gas molecule guiding geometry according to the present invention is not limited to any particular category of materials. Suitable materials for forming structures incorporating insulating spaces according to the present invention include, for example, metals, ceramics, metalloids, or combinations thereof.

The convergence of the space provides guidance of molecules in the following manner. When the gas molecule concentration becomes sufficiently low during evacuation of the space such that structure geometry becomes a first order effect, the converging walls of the variable distance portion of the space channel gas molecules in the space toward the vent. The geometry of the converging wall portion of the vacuum space functions like a check valve or diode because the probability that a gas molecule will leave the space, rather than enter, is greatly increased.

The effect that the molecule-guiding geometry of structure has on the relative probabilities of molecule egress versus entry can be understood by analogizing the converging-wall portion of the vacuum space to a funnel that is confronting a flow of particles. Depending on the orientation of the funnel with respect to the particle flow, the number of particles passing through the funnel would vary greatly. It is clear that a greater number of particles will pass through the funnel when the funnel is oriented such that the particle flow first contacts the converging surfaces of the funnel inlet rather than the funnel outlet.

Various examples of devices incorporating a converging wall exit geometry for an insulating space to guide gas particles from the space like a funnel are provided herein. It should be understood that the gas guiding geometry of the invention is not limited to a converging-wall funneling construction and can, instead, utilize other forms of gas molecule guiding geometries.

### FIGURES

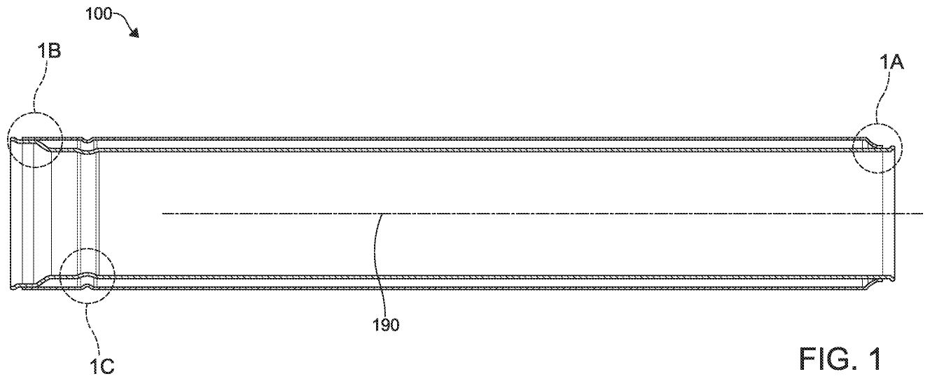

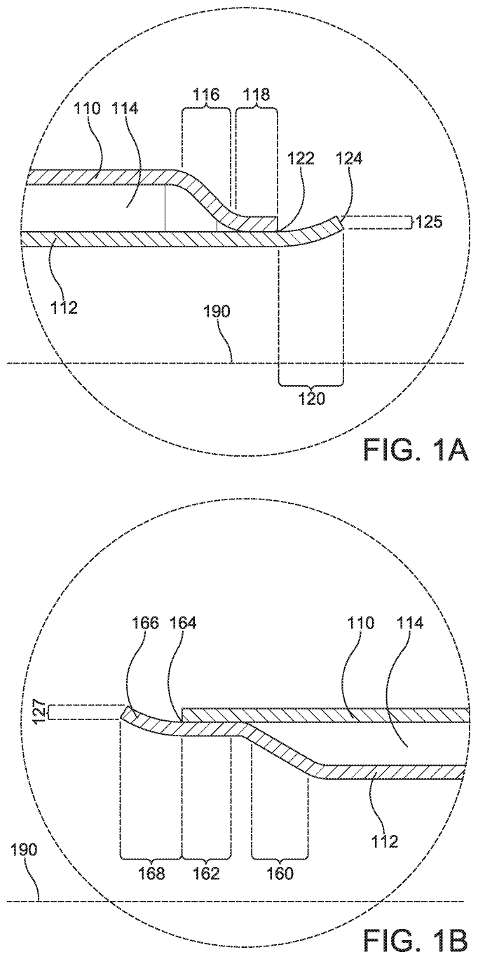

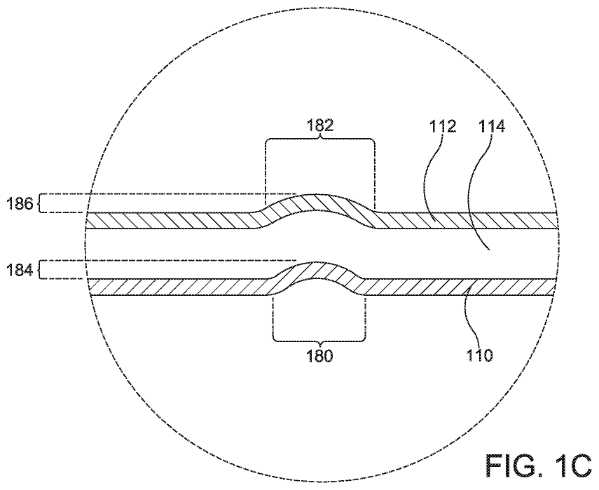

FIG. 1 provides a cutaway view of an exemplary article 100. As shown in FIG. 1, the article 100 defines a major axis 190, which major axis 190 is defined by the major axis of the lumen of the inner tube (not labeled) of the article, which inner tube is described elsewhere herein. The encircled region A at the right side of the figure corresponds to the view of FIG. 1A, and the encircled region B at the left of the figure corresponds to the view of FIG. 1B.

FIG. 1A provides a detailed view of the encircled region A at the right of FIG. 1. As shown, the article can comprise inner tube 112, which inner tube 112 defines major axis 190. Inner tube 112 has a proximal end 124 and also outflared region 120, which outflared region 120 has an increasing diameter as one follows inner tube 112 in the direction of proximal end 124. Outflared region 120 can be curved as shown in FIG. 1A (e.g., trumpet-shaped), but can also be linear (not shown). Outflared region 120 can have a length, in some embodiments, of from about 4 to about 8 times the thickness of outer tube 110, though this is not a requirement.

Outer tube 110 can include a tapered region 116, which tapered region 116 suitably tapers toward inner tube 112 as one follows outer tube 110 in the direction of proximal end 122 of outer tube 110. Tapered region 116 suitably connects to proximal joint region 118. Proximal joint region 118 can extend from the proximal end of tapered region 116 to proximal end 122 of outer tube 110.

As shown, proximal joint region 118 can overlap inner tube 112. (It should be understood that the term “overlap” does not require actual physical contact, only that one of the overlapping parts is superimposed over the other. For example, in the case of a dinner plate atop a placemat that is in turn atop a table, the dinner plate overlaps the table.) Proximal joint region 118 can be sealably joined with inner tube 112, e.g., via brazing, welding, or other methods known in the art.

Proximal joint region 118 can be joined to inner tube 112, e.g., via a brazing operation. Proximal joint region 118 can be parallel to inner tube 112. In some embodiments, the inner diameter of joint region 118 is (before tube assembly) within about 5% of the outer diameter of inner tube 112 where joint region 116 overlaps inner tube 112. In some embodiments, joint region 116 is friction-fit over inner tube 112, which can be enabled by the flexibility of outer tube 110.

As shown, outflared region 125 of inner tube 112 can define a trough that encircles the article, which trough can be adjacent to proximal end 122 of outer tube 110. As shown in FIG. 1B, the trough can have a depth 125. The depth of the trough can be defined by distance 125, which distance can be measured from the outer surface of outflared region 120 and the inner surface of joint region 118. Depth 125 can be equal to or about equal to the thickness of outer wall 110. It should be understood that either the distal end or the proximal end of a wall (inner wall or outer wall) can include an outflared region. Likewise, that either the distal end or the proximal end of a wall (inner wall or outer wall) can include a tapered (or “inflared”) region.

In some embodiments, distance 125 is equal to the thickness of outer tube 110 at distal end 122 of outer tube 110. This is not a requirement, however, as distance 125 can be greater than the thickness of outer tube 110 at proximal end 122, e.g., from about 101% to about 150% of the thickness of outer tube 110 at distal end 122.

FIG. 1B provides a detailed view of the encircled region B at the left in FIG. 1. As shown, the distal end of an article includes outer tube 110 having a distal end 164. The distal portion of outer tube 110 can be linear (i.e., unbent or uncurved as one follows along outer tube 110 in the direction of distal end 164), though this is not a requirement. Inner tube 112 can in the direction along inner tube 112 toward distal end 166, include a transition 172 and outtapered region 160.

Outtapered region 160 can, along the direction of distal end 166 of inner tube 112, define an increasing diameter, i.e., away from axis 190. Inner tube 112 can also include joint region 162 attached to outtapered region 160. Joint region 162 suitably overlaps at least a portion of outer tube 110, as shown. Inner tube 110 can further include end flare region 168, extending in the direction of distal end 166 of outer tube 110.

End flare region 168 can be curved or trumpet-shaped as shown in FIG. 1B. End flare region 168 can also be linear. Joint region 162 can be sealably joined with outer tube 110, e.g., via brazing, welding, or other methods known in the art.

As shown, end flare region 168 of inner tube 112 can define a trough that encircles the article, which trough can be adjacent to distal end 166 of outer tube 110. As shown in FIG. 1B, the trough can have a depth defined by distance 127, which distance can be measured from the outer surface of end flare region 168 and the inner surface of joint region 162.

In some embodiments, distance 127 is equal to the thickness of outer tube 110 at distal end 164 of outer tube 110. This is not a requirement, however, as distance 127 can be greater than the thickness of outer tube 110 at distal end 164, e.g., from about 101% to about 150% of the thickness of outer tube 110 at distal end 164. Alternatively, distance 127 can be less than the thickness of outer tube 110 at distal end 164. For example, distance 127 can be, e.g., from 99% to 1% of the thickness of the outer tube 110 at distal end 164.

FIG. 1C provides a magnified view of encircled region C in FIG. 1. As shown in FIG. 1D, an article can optionally include one or more indentation regions in the inner and/or outer tubes. An indentation region can act as, e.g., locating/retaining feature. An indentation region (or series of indentation regions) can also act as a bellows or other feature so as to address thermally-related axial compression and/or elongation of the article.

As shown in FIG. 1C, outer tube 110 can include indentation region 180 along its length. The width of indentation region 180 can vary according to a particular application. In some embodiments, the width can be in the range of, e.g., about 0.1 to about 5 mm. The indentation region 180 can have a height 184, which height can vary depending on the user's needs. In some non-limiting embodiments, height 184 can be, e.g., from about 0.1 to about 5 mm. Although indentation region 180 can be curved or arch-shaped as shown in exemplary FIG. 1D, indentation region 180 can have a polygonal or partially polygonal profile. (Outer tube 110 and inner tube 112 can define insulating space 114 therebetween.)

Inner tube 112 can also include indentation region 182. The width of indentation region 182 can vary according to a particular application. In some embodiments, the width can be in the range of, e.g., about 0.1 to about 5 mm. The indentation region 182 can have a height 186, which height can vary depending on the user's needs. In some non-limiting embodiments, height 186 can be, e.g., from about 0.1 to about 5 mm. Although indentation region 182 can be curved or arch-shaped as shown in exemplary FIG. 1C, indentation region 182 can have a polygonal or partially polygonal profile. Indentation region 180 and indentation region 182 can be in register with one another, e.g., a line perpendicular to the outermost point on indentation region 180 can pass through (or nearly pass through) the outermost point of indentation region 182. As explained elsewhere herein, inner tube 110 and outer tube 112 can include zero, one, two, or more indentation regions. It should be understood that indentation regions in the inner and outer tubes can have the same or different heights. It should also be understood that although the indentation regions shown in FIG. 1C are concave (i.e., bowing inward toward the center of the article), indentation regions can also be convex in nature. It should also be understood that an indentation region of one tube can differ in width from an indentation region in the other tube. For example, the width of indentation region 180 can differ from the width of indentation region 182.

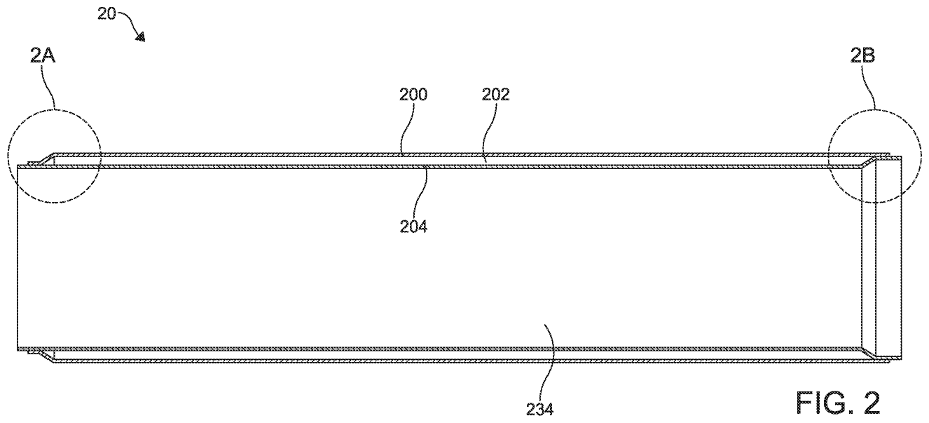

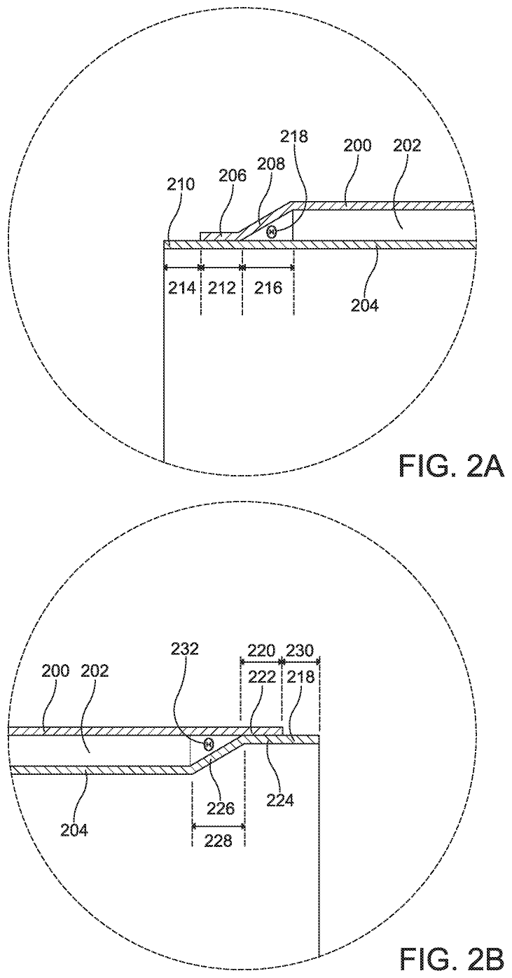

FIG. 2 provides a cutaway view of an article according to the present disclosure; the encircled region at the right of the figure is shown in FIG. 2A, and the encircled region at the left of the figure is shown in FIG. 2B. As shown, an article can include an outer wall 200, an inner wall 204, and a sealed space 202 disposed between the outer and inner walls. The article can also define a lumen 234 therein.

As shown in FIG. 2A, outer wall 200 can include a tapering region 208 and a land 206 that overlaps and can be sealed (e.g., with brazing) to inner wall 204. The land region 206 can overlap inner wall 204; the length of this overlap is shown by overlap 212. Inner wall 204 can include a region 210 that extends beyond the end of outer wall 200; the length of this extension is shown by 214. Tapering region 208 can be inclined by an angle θ (218) relative to inner wall 204, as shown; the angle 218 can be from about 1 to about 180 degrees. Distance 216 identifies the length of inner wall 204 that is overlapped by tapering region 208. As shown in FIG. 2A, outer wall 200 can taper inwardly toward inner wall 204.

It should be understood that although FIG. 2A shows the inner wall extending beyond the outer wall (shown by distance 214) as measured along the central axis of the article (not labeled), this is not a requirement. In some embodiments, the inner wall and the outer wall are coterminal with one another. In some embodiments, the outer wall extends beyond the inner wall.

FIG. 2B depicts inner wall 204 flaring outwardly toward outer wall 200. As shown, inner wall 204 can include a flared portion 226 that flares outwardly toward outer wall 200. Inner wall can include a land region 224 that at least partially overlaps (and can be sealed to) outer wall 200. The overlap is shown by distance 220. The land region 224 can extend beyond the end of outer wall 200; the length of such an extension is shown by distance 230 and extension region 218. As shown, flared region 226 can be inclined by an angle θ (232) relative to outer wall 200. Angle 232 can be from about 1 to about 180 degrees.

In exemplary embodiments, (a) the outer wall can taper toward the inner wall, (b) the inner wall can flare outward toward the outer wall, or both (a) and (b). The ends of the inner wall and the outer wall can also be coterminal, but this is not a requirement. In some embodiments, a proximal end of the outer wall can extend (measured along an axis) beyond a proximal end of the inner wall. In some embodiments, a proximal end of the inner wall can extend beyond a proximal end of the outer wall. In some embodiments, a distal end of the outer wall can extend (measured along an axis) beyond a distal end of the inner wall. In some embodiments, a distal end of the inner wall can extend beyond a distal end of the outer wall.

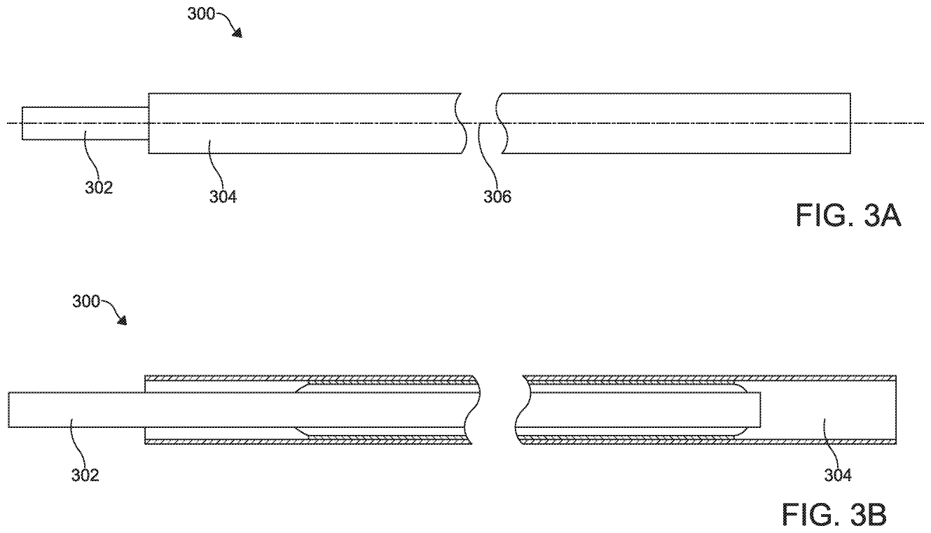

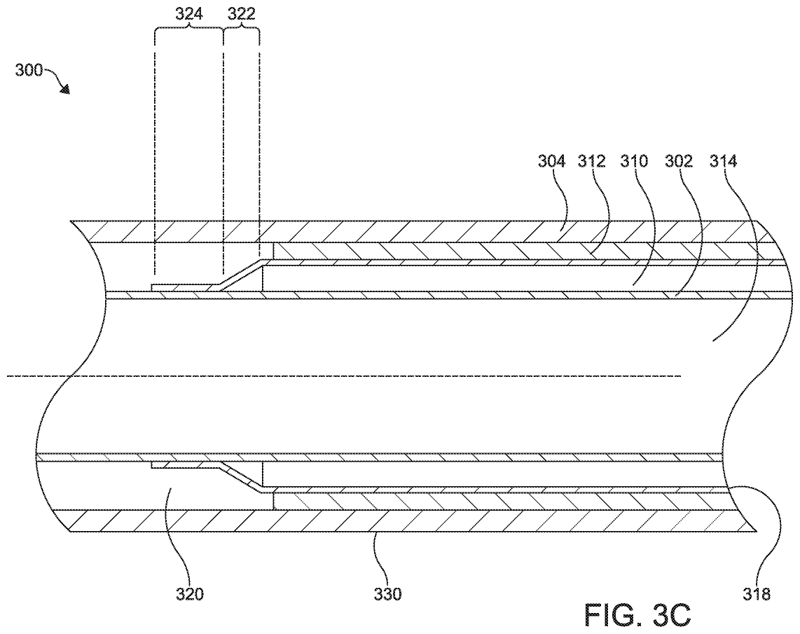

FIG. 3A provides an exterior view of an exemplary article 300. As shown, article 300 can comprise a first tube 300 disposed within third tube 304. Third tube 304 can also define major axis 306.

FIG. 3B provides a partial cutaway view of article 300. As shown, first tube 302 can be disposed within third tube 304.

FIG. 3C provides a closer view of the article of FIG. 3B. As shown, first tube 302 is disposed within second tube 318. First tube can also define lumen 314.

Second tube 318 can include a tapering region 322, which tapering region tapers toward first tube 302. Second tube can also include joint region 324, which joint region can extend from tapering region 324, and which joint region can also be sealably joined to first tube 302, e.g., via a brazing or other process.

Second tube 318 and first tube 302 can define a sealed insulating space 310. Sealed insulating space 310 is suitably evacuated, and can define a pressure of between, e.g., about 10⁻⁴ Torr to about 10⁻⁹ Torr, or even 10⁻⁴ Torr to about 10⁻⁷ Torr.

First tube 302 and second tube 318 can also be disposed within third tube 304. An adhesive (e.g., a compliant adhesive) 312 can be disposed in the space between second tube 318 and third tube 304. Third tube 304 can define a space 320 between the third tube and the first and second tube. Space 320 can be sealed by adhesive 312 and by one or more baffles (not shown) or other structures. Space 320 can be at ambient pressure, but can also be evacuated.

As shown in FIG. 3C, third tube 304 can define axis 306. Axis 306 can be the major axis of third tube 304, but can also lie along the major axes of the first, second, and third tubes, as the tubes can be arranged in a coaxial manner. Third tube can also define surface line 330, which line runs along the outer surface of third tube 104 and is parallel to the major axis of the third tube.

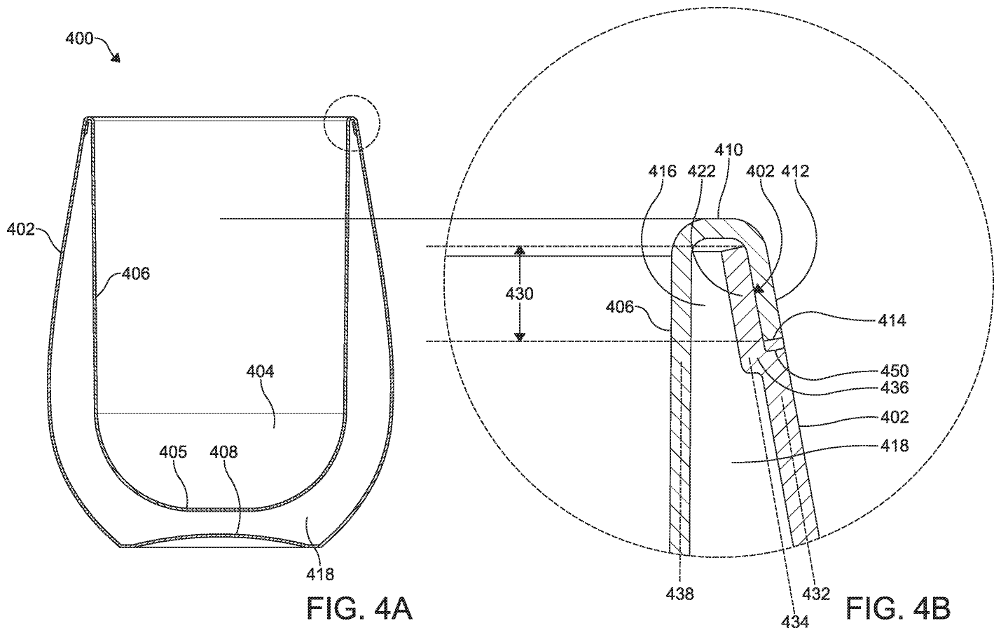

The attached figures provide exemplary, non-limiting embodiments of the disclosed technology. FIG. 4A provides an exemplary vessel 400. As shown in FIG. 4, vessel 400 can comprise an outer wall 402 (which can be cylindrical or cup-shaped) and an inner wall 406 (which can also be cylindrical or cup-shaped), which outer and inner walls define therebetween a first insulating space 418. As shown, outer wall 402 and inner wall 406 can be U-shaped. Outer wall 402 can have a bottom portion 408, which bottom portion can be flat, concave (as shown in exemplary FIG. 4A), convex, or any combination thereof. For example, the bottom portion 408 can be outwardly convex, but can include a flat portion such that the vessel can rest stably on a surface, e.g., a table, countertop, or bar. Vessel 400 can have a liquid 404 or other material disposed therein. Vessel 400 can also include a lid (not shown) that seals the interior volume of the vessel defined by the lid and inner wall 406.

FIG. 4B provides a more detailed view of the circled portion in the upper right hand region of FIG. 4A, which circled portion highlights the union between outer wall 402 and inner wall 406 of vessel 400. As shown in FIG. 4B, approaching the union of outer wall 402 and inner wall 406, outer wall 402 can extend at an angle defined by outer wall angle line 432 and a vertical line, in the direction of outer wall 402.

The angle between outer wall angle line 432 and the vertical line is suitably less than 45 degrees, e.g., less than about 45, less than about 40, less than about 35, less than about 30, less than about 25, less than about 20, less than about 15, less than about 10, or even less than about 5 degrees. It should be understood that the foregoing angles are exemplary only, and other angles are within the scope of the present disclosure.

Approaching the union of outer wall 402 and inner wall 406, inner wall 406 can extend at an angle defined by inner wall angle line 438 and a vertical line, in the direction of inner wall 406. The angle between inner wall angle line 438 and the vertical line is suitably less than 45 degrees, e.g., less than about 45, less than about 40, less than about 35, less than about 30, less than about 25, less than about 20, less than about 15, less than about 10, or even less than about 5 degrees. It should be understood that the foregoing angles are exemplary only, and other angles are within the scope of the present disclosure.

As shown in FIG. 4B, outer wall 402 can include a kink portion 436, which kink portion connects to outer wall joint portion 422. Joint portion 422 can extend along joint portion line 434. The angle between joint portion line 434 and outer wall angle line 432 can be 0 degrees (when joint portion 422 is parallel to outer wall 402), but the angle between joint portion line 434 and outer wall angle line 432 can be, e.g. from about 20 to about −20 degrees, e.g., −20, −15, −10, −5, 0, 5, 10, 15, or even 20 degrees. Joint portion 422 of outer wall 402 can overlap with hook portion 412 of inner wall 406, which hook portion 412 is connected to inner wall 406 by way of the inner wall's curved portion 410. The overlap between joint portion 422 and hook portion 412 can be defined by overlap region 430; overlap region 430 can be a braze joint or other joint.

The overlap region 430 and hook portion 412 can be contiguous with one another. As shown in FIG. 4B, hook portion 412 of inner wall 406 can extend to kink portion 436. The joint 414 between kink portion 436 and hook portion 412 can be an overlap only, but can also be a braze or other joint.

Kink portion 436 of outer wall 402 can extend toward inner wall 406 and define distance 450. Distance 450 can be the same as the thickness of hook portion 412 of inner wall 402 (though this is not a requirement), so as to allow for joint 414 between hook portion 412 and kink region 436 to be flush.

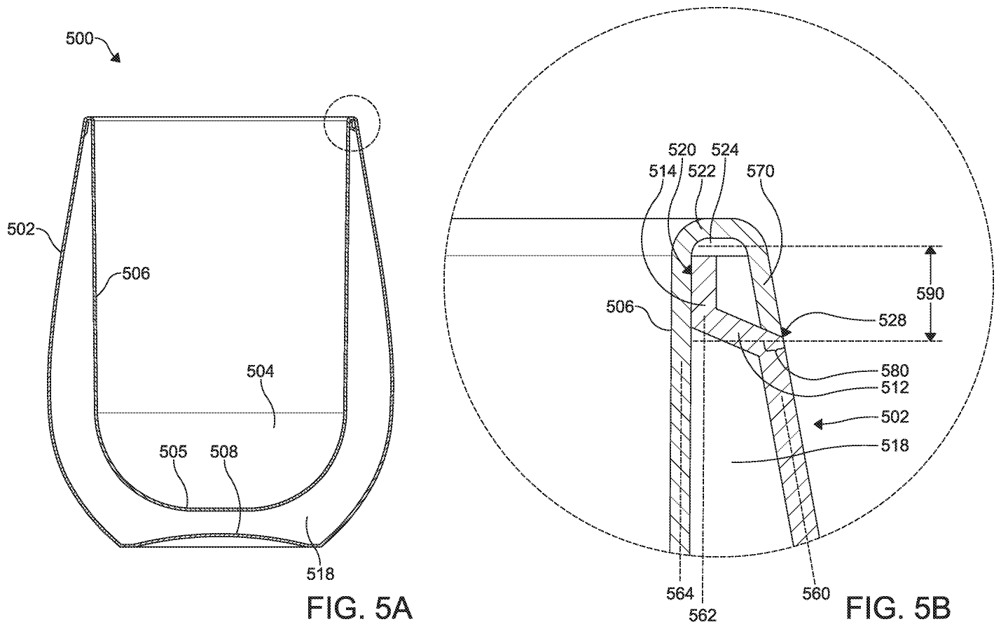

FIG. 5A provides an exemplary vessel 500. As shown in FIG. 5A, vessel 500 can comprise an outer wall 502 (which can be cylindrical or cup-shaped) and an inner wall 506 (which can also be cylindrical or cup-shaped), which outer and inner walls define therebetween a first insulating space 518. As shown, outer wall 502 and inner wall 506 can be U-shaped. Outer wall 502 can have a bottom portion 508, which bottom portion can be flat, concave (as shown in exemplary FIG. 5A), convex, or any combination thereof. For example, the bottom portion 508 can be outwardly convex, but can include a flat portion such that the vessel can rest stably on a surface, e.g., a table, countertop, or bar. Vessel 500 can have a liquid 504 or other material disposed therein. Vessel 500 can also include a lid (not shown) that seals the interior volume of the vessel defined by the lid and inner wall 506.

FIG. 5B provides a more detailed view of the circled portion in the upper right hand region of FIG. 5A, which circled portion highlights the union between outer wall 502 and inner wall 506 of vessel 500. As shown in FIG. 5B, outer wall 502 can include a kink portion 512, which kink portion connects to outer wall joint portion 514.

Joint portion 514 can extend along joint portion line 562. The angle between joint portion line 562 and inner wall angle line 564 can be 0 degrees (when joint portion 514 is parallel to inner wall 506), but the angle between joint portion line 562 and outer wall angle line 564 can be, e.g. from about 20 to about −20 degrees, e.g., −20, −15, −10, −5, 0, 5, 10, 15, or even 20 degrees. Joint portion 514 of outer wall 502 can overlap with inner wall 506, with an overlap region 590. Inner wall 506 can have a hook portion 570 that is connected to inner wall 506 by way of curved portion 522. The overlap between the joint portion 514 and inner wall 506 can be a braze joint or other joint. Hook portion 570 can be joined to outer wall 502 at joint 528, which joint can be a braze or other type of joint. Outer wall 502 can be flush with hook region 570 at joint 528. Space 526 can be bounded by hook portion 570, curved region 522, joint portion 514, and kink portion 512. Space 526 can be evacuated, but this not is a requirement. Hook portion 570 can have a thickness 580, which thickness 580 can be less than the distance by which kink 512 extends from outer wall 502 toward inner wall 506.

As shown in FIG. 5B, approaching the union of outer wall 502 and inner wall 506, outer wall 502 can extend at an angle defined by outer wall angle line 560 and a vertical line, in the direction of outer wall 502. The angle between outer wall angle line 560 and the vertical line is suitably less than 45 degrees, e.g., less than about 45, less than about 40, less than about 35, less than about 30, less than about 25, less than about 20, less than about 15, less than about 10, or even less than about 5 degrees. It should be understood that the foregoing angles are exemplary only, and other angles are within the scope of the present disclosure.

Inner wall 506 can extend at an angle defined by inner wall angle line 564 and a vertical line, in the direction of inner wall 506. The angle between inner wall angle line 564 and the vertical line is suitably less than 45 degrees, e.g., less than about 45, less than about 40, less than about 35, less than about 30, less than about 25, less than about 20, less than about 15, less than about 10, or even less than about 5 degrees. It should be understood that the foregoing angles are exemplary only, and other angles are within the scope of the present disclosure.

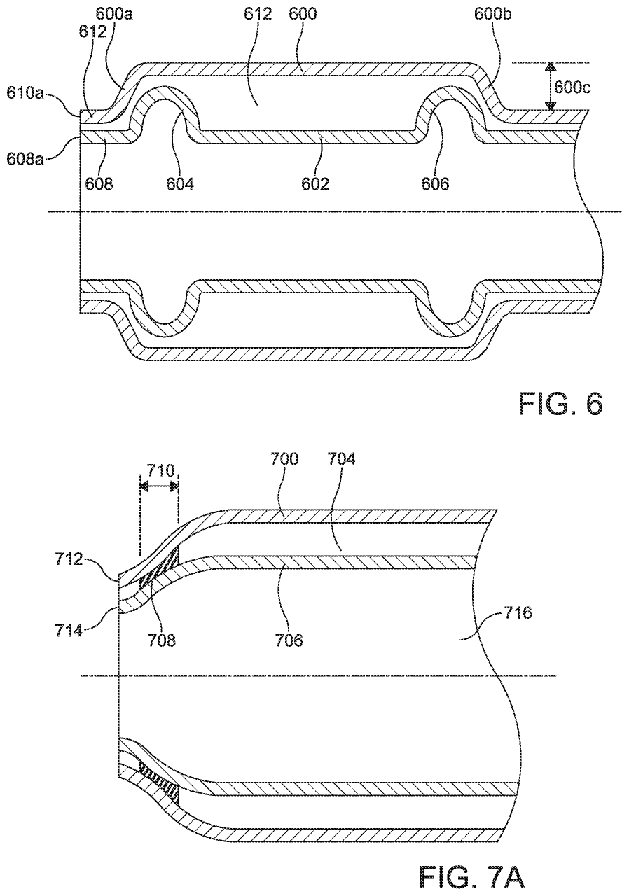

FIG. 6 provides a cutaway view of an article according to the present disclosure. As shown, an article can include an outer wall 600, which outer wall can include a first tapered region 600a and a second tapered region 600b spaced apart from one another. Tapered regions 600a and 600b can defines therebetween an outbulged region (not labeled) that connects the tapered regions.

The tapered regions can act to reduce the internal diameter of the outer wall 600 by an amount 600c. As shown, outer wall 600 can include a land region 610 and also an end 610a. Inner wall 602 can include flared portions 604 and 606, which flared portions can flare toward outer wall 600. The flared portions can define therebetween a connecting region (not labeled). Inner wall 600 can also include a land portion 608, which land portion can overlap the land portion 610 of the outer wall 600; inner wall also includes an end 608a.

Outer wall 600 can be sealed (e.g., via brazing) to inner wall 602 at one or more locations, e.g., between outer wall land portion 610 and inner wall land portion 608. Outer wall 600 and inner wall 602 can also be sealed to one another at a location where one of the two walls approaches the other, e.g., at flared portion 604 and/or flared portion 606. The sealing can be accomplished so as to give rise to sealed insulating space 612 between inner wall 602 and outer wall 600; sealed insulating space 612 can be at reduced pressure, as described elsewhere herein. Without being bound to any particular theory or embodiment, the tapered regions of the outer wall can be of assistance in positioning the inner wall relative to the outer tube. In one embodiment, the inner and outer walls are positioned relative to one another such that one or more flared regions of the inner wall are positioned within a region of the outer wall that has a relatively larger diameter.

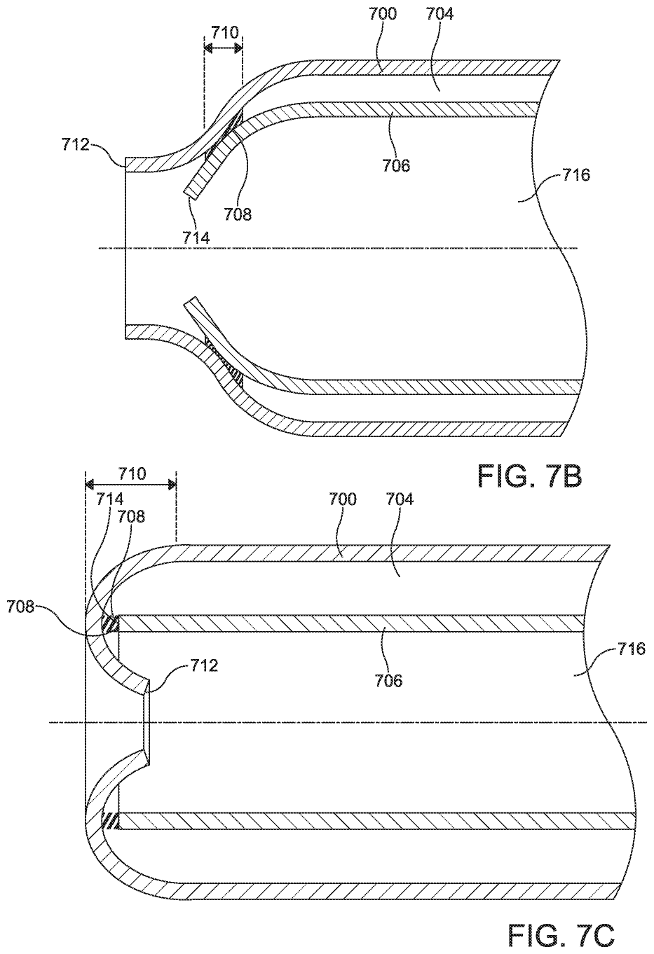

FIGS. 7A, 7B, and 7C provide further exemplary embodiments of the disclosed technology. As shown in FIG. 7A, an article can include an outer wall 700 and an inner wall 706, which in turn define a sealed insulating space 704 therebetween. As shown, outer wall 700 can include a tapered portion 710 that tapers toward inner wall 706; inner wall 706 can also include a tapered portion (not labeled) as well. Outer wall 700 can be sealed to inner wall 706 via, e.g. brazing, welding, or other methods known to those of skill in the art. (An exemplary amount of braze material is shown by element 708.) The end 712 of the outer wall 700 and the end 714 of the inner wall can be coterminal, but either of end 712 or end 714 can extend beyond the other end. It should be understood that the tapered region 710 of outer wall 700 can have a constant taper, but can also have a variable taper along its length. Likewise, the tapered region of inner wall 706 can have a constant taper, but can also have a variable taper along its length. The taper of the outer and inner walls can be equal, but can be different from one another. As an example, outer wall 700 can have a greater taper per length along one or more regions than the taper per length of inner wall 706 at one or more regions. (The article can define a lumen 716 therein.)

FIG. 7B provides another alternative embodiment of an article according to the present disclosure. As shown, an article can include an outer wall 700 and an inner wall 706, which in turn define a sealed insulating space 704 therebetween. As shown, outer wall 700 can include a tapered portion 710 that tapers toward inner wall 706; inner wall 706 can also include a tapered portion (not labeled) as well. Outer wall 700 can be sealed to inner wall 706 via, e.g. brazing, welding, or other methods known to those of skill in the art. (An exemplary amount of braze material is shown by element 708.) The end 712 of the outer wall 700 and the end 714 of the inner wall can be coterminal, but either of end 712 or end 714 can extend beyond the other end. It should be understood that the tapered region 710 of outer wall 700 can have a constant taper, but can also have a variable taper along its length. Likewise, the tapered region of inner wall 706 can have a constant taper, but can also have a variable taper along its length. The taper of the outer and inner walls can be equal, but can be different from one another. As an example, outer wall 700 can have a greater taper per length along one or more regions than the taper per length of inner wall 706 at one or more regions. As shown in FIG. 7B, the inner wall 706 and outer wall can have opposing tapers such that the walls extend, curve or diverge away from one another as shown in FIG. 7B. The inner and outer walls can be sealed to one another at a relative inflection point in one or both of the walls' curvatures. (The article can define a lumen 716 therein.)

FIG. 7C provides another alternative embodiment of an article according to the present disclosure. As shown, an article can include an outer wall 700 and an inner wall 706, which in turn define a sealed insulating space 704 therebetween. As shown, outer wall 700 can include a portion (not labeled) that tapers toward inner wall 706; inner wall 706 can also include a tapered portion (not labeled) as well. Outer wall 700 can be sealed to inner wall 706 via, e.g. brazing, welding, or other methods known to those of skill in the art. (An exemplary amount of braze material is shown by element 708.) As shown, outer wall 700 can have an end 712, and outer wall 700 can extend beyond and then “hook” back over end 714 of inner wall 706, as shown by hooked portion 710a. (The article can define a lumen 716 therein.) In FIG. 7C, inner wall 706 is joinded to outer wall 700 at the end 714 of inner wall 706 at the apex of hooked region 710a, it should be understood that the joint can be at other locations along the inner wall and the outer wall and does not need to be at an end of either of the two walls.

The end 712 of the outer wall 700 and the end 714 of the inner wall can be coterminal, but either of end 712 or end 714 can extend beyond the other end. It should be understood that the hooked region 710a of outer wall 700 can have a constant curvature, but can also have a variable curvature along its length. Likewise, a tapered region of inner wall 706 can have a constant taper, but can also have a variable taper along its length. The taper of the outer and inner walls can be equal, but can be different from one another. Although inner wall 706 is shown as straight in FIG. 7C, it should be understood that the inner wall can be flared, tapered, or otherwise non-linear, depending on the user's needs.

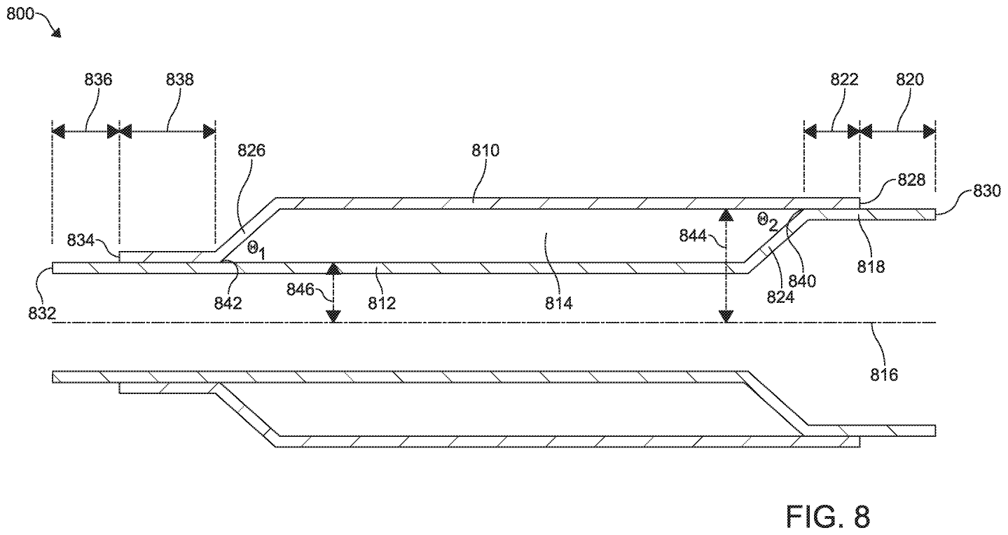

FIG. 8 provides a cutaway view of an exemplary article 800 according to the present disclosure. As shown, outer wall 810 and inner wall 812 are sealed together to form an insulating space (which can be evacuated) 814 therebetween. (As described elsewhere herein, the insulating space can be at reduced pressures of less than 1 atm, e.g., from 10⁻² to 10⁻⁷ Torr, for example.

As shown, outer wall 810 can include a tapered portion 826 that converges toward inner wall 812. The proximal end 832 of inner wall 812 can extend beyond (as measured along central axis 816 of article 80) the proximal end 834 of outer wall 810, by distance 836. As described elsewhere herein, however, the ends of the inner and outer walls can be coterminal with one another. In some embodiments, the end of the inner wall extends beyond the end of the outer wall. In some embodiments, the end of the outer wall extends beyond the end of the inner wall. (Central axis 216 extends through the lumen formed within inner tube 812, which lumen is not labeled in FIG. 8.)

As shown, outer wall 810 defines a proximal land portion that overlaps inner wall 812 by distance 838. The inner and outer walls are joined at proximal vent 842, which is located at a proximal vent radial distance 846 from central axis 816. At vent 842, an angle θ1 is formed between inner wall 812 and outer wall 810; the angle θ1 can be from 0 to 180 degrees, in some embodiments.

Inner wall 812 can include a flared portion 824 that flares outwardly toward outer wall 810. The distal end 830 of inner wall 812 can extend beyond (measured along central axis 816 of article 80) the distal end 828 of outer wall 810, by distance 820. As described elsewhere herein, however, the ends of the inner and outer walls can be coterminal with one another. In some embodiments, the end of the inner wall extends beyond the end of the outer wall. In some embodiments, the end of the outer wall extends beyond the end of the inner wall.

As shown, outer wall 810 defines a distal land portion that overlaps inner wall 812 by distance 822. The inner and outer walls are joined at distal vent 840, which is located at a distal vent radial distance 844 from central axis 816. At vent 840, an angle θ2 is formed between inner wall 812 and outer wall 810; the angle θ2 can be from 0 to 180 degrees, in some embodiments. It should be understood that proximal vent radial distance 846 can be the same as distal radial vent distance 844, but this is not a requirement.

In some embodiments, proximal vent radial distance 846 differs from distal vent radial distance 844; for example, proximal vent radial distance 846 can be less than distal vent radial distance 844. The ratio of proximal vent radial distance 846 to distal vent radial distance 844 can be from 1:1.0001 to 1:10, from 1:1.001 to 1:5, from 1:1.01 to 1:2, and all intermediate values.

Exemplary Embodiments

The following embodiments are exemplary only and do not limit the scope of the present disclosure.

Embodiment 1. A vacuum-insulated article, comprising: an outer tube having a proximal end and a distal end; and an inner tube having a proximal end, a distal end, and a lumen, the inner tube being disposed within the outer tube and the inner tube having a major axis of the lumen of the inner tube, the inner tube and the outer tube defining an evacuated insulating space therebetween, the inner tube comprising a outflared region having an increasing diameter along the direction of the proximal end of the inner tube, the ouflared region extending toward the proximal end of the inner tube, at least a portion of the outflared region extending beyond the proximal end of the outer tube, as measured along the major axis, the proximal end of the inner tube extending beyond the proximal end of the outer tube, as measured along the major axis, the outer tube comprising a tapered region having a decreasing diameter in the direction of the proximal end of the outer tube, the outer tube comprising a proximal joint region extending from the tapered region of the outer tube in the direction of the proximal end of the outer tube, and the proximal joint region of the outer tube overlapping a portion of the inner tube.

The lumen of the inner tube can have a diameter according to the needs of a particular application. In some embodiments, the lumen is in the range of from about 0.75 mm to 305 mm. The radial distance between inner and outer tubes can be, e.g., about 0.10 mm to about, e.g., 1 mm or even about 3 mm, although the radial distance can vary depending on the user's needs. One or both of the inner or outer tubes can be formed from stainless steel.

The tapered region 116 can be curved in cross-section as shown in FIG. 1B, but this is not a requirement. Tapered region 116 can have a linear cross-section.

Embodiment 2. The article of embodiment 1, wherein: the inner tube comprises an outtapered region having an increasing diameter along the direction of the distal end of the inner tube, the inner tube comprises a distal joint region extending from the outtapered region in the direction of the distal end of the inner tube, the inner tube comprises an end flare region extending from the joint region in the direction of the distal end of the inner tube, the end flare region having an increasing diameter along the direction of the distal end of the inner tube, at least a portion of the endflared region of the inner tube extending beyond the distal end of the outer tube, as measured along the major axis, and the distal end of the inner tube extending beyond the distal end of the outer tube, as measured along the major axis.

Embodiment 3. The article of any of embodiments 1-2, further comprising an amount of a braze material disposed between the proximal joint region of the outer tube and the inner tube. The braze material can be disposed between the proximal joint region of the outer tube and the inner tube by placement on one or both of the foregoing before assembly. Alternatively, the braze material can be disposed by capillary action, which is described in, e.g., U.S. Pat. Nos. 7,374,063; 7,681,299; and 8,353,332, all of which are incorporated herein in their entireties for any and all purposes.

Embodiment 4. The article of any of embodiments 2-3, further comprising an amount of a braze material disposed between the distal joint region of the inner tube and the outer tube.

Embodiment 5. The article of any of embodiments 1-3, wherein the outflared region of the inner tube and the proximal end of the outer tube define a proximal end trough.

Embodiment 6. The article of embodiment 5, further comprising an amount of a braze material disposed in the proximal end trough.

Embodiment 7. The article of any of embodiments 1-6, wherein the endflared region of the inner tube and the distal end of the outer tube define a distal end trough.

Embodiment 8. The article of embodiment 7, further comprising an amount of braze material disposed in the distal end trough.

Embodiment 9. The article of any of embodiments 1-8, wherein the evacuated insulating space has a pressure of between about 10⁻⁴ Torr and 10⁻⁹ Torr.

Embodiment 10. The article of embodiment 9, wherein the evacuated insulating space has a pressure of between about 10⁻⁴ Torr and 10⁻⁷ Torr.

Embodiment 11. The article of any of embodiments 1-10, wherein the proximal joint region of the outer tube is essentially parallel to the inner tube.

Embodiment 12. The article of any of embodiments 1-11, wherein the inner tube comprises one or more indentation regions, wherein the outer tube comprises one or more indentation regions, or both.

Embodiment 13. The article of embodiment 12, wherein the inner tube comprises an indentation region that is in register with an indentation region of the outer tube.

Embodiment 14. The article of any of embodiments 12-13, wherein one or both of the inner and outer tubes comprises two or more indentation regions.

Embodiment 15. A method, comprising: communicating storing a fluid in the lumen of the inner tube of an article according to any of embodiments 1-14, communicating a fluid within the lumen of the inner tube of an article according to any of embodiments 1-11, or both.

Embodiment 16. A method, comprising: with (a) an inner tube comprising a proximal end, a distal end, a major axis, and a lumen, the inner tube further comprising a outflared region having an increasing diameter along the direction of the proximal end of the inner tube, the outflared region extending toward the proximal end of the inner tube, and (b) an outer tube comprising a proximal end and a distal end, the outer tube further comprising a tapered region having a decreasing diameter in the direction of the proximal end of the outer tube, the outer tube comprising a proximal joint region extending from the tapered region of the outer tube in the direction of the proximal end of the outer tube, assembling the inner and outer tube so as to dispose the inner tube within the outer tube such that at least a portion of the outflared region of the inner tube extends beyond the proximal end of the outer tube, as measured along the major axis, the proximal end of the inner tube extends beyond the proximal end of the outer tube, as measured along the major axis, and the proximal joint region of the outer tube overlaps at least a portion of the inner tube. Without being bound to any particular approach, an article can be assembled by relative motion between the inner and outer tubes, following by joining the tubes (e.g., via brazing) as needed.

The result of one such method is shown in FIGS. 1A, 1B, 1C, and 1D, which FIGS. illustrate one result of the foregoing assembly process.

Embodiment 17. The method of embodiment 16, further comprising sealing the proximal joint region of the outer tube to the inner tube so as to define a sealed space between the inner tube and the outer tube. The sealing can be effected by brazing, welding, or by other methods known to those of ordinary skill in the art. Some such methods can be found in the various documents cited herein.

Embodiment 18. The method of embodiment 17, wherein the sealing is effected by brazing.

Embodiment 19. The method of embodiment 18, wherein the sealed space defines a pressure of from about 10⁻⁴ Torr to about 10⁻⁹ Torr.

Embodiment 20. The method of embodiment 19, wherein the sealed space defines a pressure of from about 10⁻⁴ Torr to about 10⁻⁷ Torr.

Embodiment 21. The method of any of embodiments 16-20, wherein the inner tube comprises an outtapered region having an increasing diameter along the direction of the distal end of the inner tube, the inner tube comprises a distal joint region extending from the outtapered region in the direction of the distal end of the inner tube, the inner tube comprises an end flare region extending from the joint region in the direction of the distal end of the inner tube, the end flare region having an increasing diameter along the direction of the distal end of the inner tube, and the inner and outer tubes are assembled such that at least a portion of the endflared region of the inner tube extends beyond the distal end of the outer tube, as measured along the major axis, and the distal end of the inner tube extends beyond the distal end of the outer tube, as measured along the major axis.

Embodiment 22. The method of embodiment 21, further comprising sealing the distal joint region of the inner tube to the outer tube.

Embodiment 23. The method of embodiment 22, wherein the sealing is effected by brazing.

Embodiment 24. The method of any of embodiments 16-23, wherein one or both of the inner tube and outer tube comprises one or more indentation regions.

Embodiment 25. A vacuum-insulated article, comprising: a first wall bounding an interior volume; a second wall spaced at a distance from the first wall to define an insulating space therebetween, the first and second walls provided by first and second tubes substantially concentric with each other, a vent communicating with the insulating space to provide an exit pathway for gas molecules from the space, the vent being sealable for maintaining a vacuum within the insulating space following evacuation of gas molecules through the vent, the distance between the first and second walls being variable in a portion of the insulating space adjacent the vent such that gas molecules within the insulating space are directed towards the vent by the variable-distance portion of the first and second walls during the evacuation of the insulating space, the directing of the gas molecules by the variable-distance portion of the first and second walls imparting to the gas molecules a greater probability of egress from the insulating space than ingress, at least one of the first and second walls including a portion that converges toward the other wall adjacent the vent, and wherein the distance between the walls is at a minimum adjacent the location at which the vent communicates with the insulating space; and a third wall, the third wall disposed at a distance from the second wall and the third wall provided by a third tube substantially concentric with the first and second tubes, the third tube defining a major axis, the second and third walls defining a distance therebetween; and an adhesive material disposed between the second and third walls so as to effect structural reinforcement by the third wall of the second wall.

Embodiment 26. The article of embodiment 25, wherein the distance between the second and third walls is from about 0.02 to about 0.8 inches.

Embodiment 27. The article of embodiment 26, wherein the distance between the second and third walls is from about 0.04 to about 0.6 inches.

Embodiment 28. The article of embodiment 26, wherein the distance between the second and third walls is between 0.4 and 0.5 inches.

Embodiment 29. The article of any of embodiments 25-28, wherein the third tube defines an outer diameter of from about 1 to about 5 mm, e.g., 1.2 to 4.5 mm, 1.5 to 4.2 mm, 1.7 to 3.8 mm, or even 2.1 to 2.9 mm.

Embodiment 30. The article of embodiment 29, wherein the third tube defines an outer diameter of from about 1 to about 3 mm, e.g., 1.1 to 2.9 mm, 1.2 to 2.8 mm, 1.3 to 2.7 mm, 1.4 to 2.6 mm, 1.5 to 2.5 mm, 1.6 to 2.4 mm, 1.7 to 2.3 mm, 1.8 to 2.2 mm, 1.9 to 2.1 mm, or even 2 mm.

Embodiment 31. The article of embodiment 30, wherein the third tube defines an outer diameter of from about 1 to about 2 mm, e.g., 1.1 to 1.9 mm, 1.2 to 1.8 mm, 1.3 to 1.7 mm, 1.4 to 1.6 mm, or even 1.5 mm.

Embodiment 32. The article of any of embodiments 25-31, wherein the second tube defines an outer diameter of from about 1 to about 1.5 mm, e.g., 1.1 to 1.5 mm, 1.2 to 1.4 mm, or even 1.3 mm.

Embodiment 33. The article of any of embodiments 25-32, wherein the first tube defines a proximal end and a distal end, wherein the third tube defines a proximal end and a distal end, and wherein the proximal end of the first tube extends beyond the proximal end of the third tube. One such embodiment is shown in FIG. 1, where the proximal (left-hand) end of first tube 102 extends beyond the proximal end of third tube 104.

Embodiment 34. The article of any of embodiments 25-33, wherein the lumen of the first tube is in fluid communication with a source of fluid. This can be effected by a tube (flexible or rigid). A variety of fluids can be used, e.g., saline, blood, liquid nitrogen, liquid helium, and the like. Gases that have been cooled down to liquid form (e.g., liquid nitrogen) are considered especially useful for use with the disclosed articles.

Embodiment 35. The article of any of embodiments 25-34, further comprising an amount of liquid nitrogen disposed within the lumen of the first tube.

Embodiment 36. The article of any of embodiments 25-35, wherein the third tube has an outer surface and defines a surface line running along the outer surface and parallel to the major axis of the third tube, and wherein the surface line deviates by no more than about 10 degrees from parallel with the major axis of the third tube when a fluid of no colder than −320 deg. F. carried in the lumen of the first tube.

Without being bound to any particular theory, the presence of the adhesive between the second and third tubes allows the article to maintain its columnar form when fluids are communicated through the article, e.g., through the lumen of first tube 102. In particular, communicating a relatively cold fluid (e.g., liquid nitrogen or other liquefied gas) can result in contraction or other bending of the first tube, the second tube, or even both in some instances.

This contraction and/or bending can, if unchecked, disturb the overall configuration of the article and can, for example, result in a cannula-configured article bending and deviating from its original straight structure. A bent cannula that is meant to be straight can in in turn present challenges to the user, as it can be difficult to insert, turn, or otherwise manipulate the cannula, in particular if the cannula has changes shape during operation (e.g., during delivery of a relatively cold fluid) following insertion into a patient. Again without being bound to any particular theory, the presence of the adhesive imparts additional structural rigidity to the article, as the adhesive allows for sharing of structural loads among the various walls of the article.

Embodiment 37. The article of any of embodiments 25-36, wherein the adhesive material comprises a cyanoacrylate. An adhesive that is compatible with cryogenic temperatures is one that is compatible with temperatures of at least −100 deg. C. Adhesives having comparatively low viscosities, i.e., so that they can be introduced effectively into relatively narrow spaces between walls, are considered suitable. One can include in the adhesive one or more additives that slow the curing of the adhesive such that the adhesive remains at a relatively low viscosity so as to facilitate delivery of the adhesive into a comparatively confined space.

Embodiment 38. The article of any of embodiments 25-37, wherein the first tube defines a length of from about 1 to about 10 inches. It should be understood that the technology of the present disclosure is not limited to first tubes of any particular length, as the length of the first tube can be dictated at least somewhat by the needs of the user or the application to which a given article can be put.

Embodiment 39. The article of any of embodiments 25-38, wherein the second tube defines a length of from about 1 to about 10 inches. It should be understood that the technology of the present disclosure is not limited to second tubes of any particular length, as the length of the second tube can be dictated at least somewhat by the needs of the user or the application to which a given article may be put.

Embodiment 40. The article of any of embodiments 25-39, wherein the second tube has a length less than that of the first tube.

Embodiment 41. A method, comprising: communicating a fluid through the lumen of the first tube of an article according to any of embodiments 25-40. As described elsewhere herein, the fluid can be liquid nitrogen or other cryogenic fluid. This can be done in the context of surgery or other medical procedure, e.g., to deliver liquid nitrogen to a site on or within a patient.

Embodiment 42. The method of embodiment 41, wherein the fluid has a temperature of less than 0 deg. C.

Embodiment 43. The method of embodiment 42, wherein the fluid has a temperature in the range of from about 0 deg. C (32 deg. F.) to about −300 or even about −459 deg. F. As some examples, the fluid can include liquid nitrogen, which can have a temperature of −321 deg. F. The fluid can also include liquid hydrogen, which can have a temperature of −423 deg. F, or even liquid helium, which can have a temperature of about −452 deg. F.

Embodiment 44. The method of any of embodiments 41-43, wherein the fluid is communicated so as to contact a patient.

Embodiment 45. A vacuum-sealed container, comprising:

a circumferentially-extending, substantially U-shaped outer wall;

a circumferentially-extending, substantially U-shaped inner wall, the inner wall and outer wall defining a sealed space therebetween;

the outer wall including a kink portion,

the kink portion extending toward the inner wall and the kink portion connecting the outer wall to a joint portion of the outer wall,

the joint portion of the outer wall overlapping with a hook portion of the inner wall, the hook portion of the inner wall being connected to the inner wall by a curved portion of the inner wall, and

(a) the hook portion of the inner wall being sealably joined to the kink portion of the outer wall,

(b) the joint portion of the outer wall being sealably joined to the hook portion of the inner wall, or

both (a) and (b).

The sealed space (also termed insulating space) can be evacuated, e.g., a vacuum space. Some exemplary vacuum-insulated structures (and related techniques for forming and using such structures) can be found in United States published patent applications 2015/0110548, 2014/0090737, 2012/0090817, 2011/0264084, 2008/0121642, and 2005/0211711, all by A. Reid, and all incorporated herein by reference in their entireties for any and all purposes.

As explained in U.S. Pat. Nos. 7,681,299 and 7,374,063 (incorporated herein by reference in their entireties for any and all purposes), the geometry of the insulating space can be such that it guides gas molecules within the space toward a vent or other exit from the space. The width of the vacuum insulating space need not be not uniform throughout the length of the space. The space can include an angled portion such that one surface that defines the space converges toward another surface that defines the space. As a result, the distance separating the surfaces can vary adjacent the vent such the distance is at a minimum adjacent the location at which the vent communicates with the vacuum space. The interaction between gas molecules and the variable-distance portion during conditions of low molecule concentration serves to direct the gas molecules toward the vent.

The molecule-guiding geometry of the space provides for a deeper vacuum to be sealed within the space than that which is imposed on the exterior of the structure to evacuate the space. This somewhat counterintuitive result of deeper vacuum within the space is achieved because the geometry of the present invention significantly increases the probability that a gas molecule will leave the space rather than enter. In effect, the geometry of the insulating space functions like a check valve to facilitate free passage of gas molecules in one direction (via the exit pathway defined by vent) while blocking passage in the opposite direction. It should be understood that a user can create a vacuum within the insulating space that is greater/deeper than the vacuum within the system (e.g., a vacuum chamber or vacuum furnace) that is used to give rise to the insulating space. Without being bound to any particular theory, the geometry of the insulating space can give rise to an ultimate within the insulating space that is greater/deeper than the vacuum within the vacuum furnace or vacuum chamber in which the insulating space is formed.

Another benefit associated with the deeper vacuums provided by the geometry of insulating space is that it is achievable without the need for a getter material within the evacuated space. The ability to develop such deep vacuums without a getter material provides for deeper vacuums in devices of miniature scale and devices having insulating spaces of narrow width where space constraints would limit the use of a getter material.

Other vacuum-enhancing features can also be included, such as low-emissivity coatings on the surfaces that define the vacuum space. The reflective surfaces of such coatings, generally known in the art, tend to reflect heat-transferring rays of radiant energy. Limiting passage of the radiant energy through the coated surface enhances the insulating effect of the vacuum space.

In some embodiments, an article can comprise first and second walls spaced at a distance to define an insulating space therebetween and a vent communicating with the insulating space to provide an exit pathway for gas molecules from the insulating space. The vent is sealable for maintaining a vacuum within the insulating space following evacuation of gas molecules through the vent. The distance between the first and second walls is variable in a portion of the insulating space adjacent the vent such that gas molecules within the insulating space are directed towards the vent during evacuation of the insulating space. The direction of the gas molecules towards the vent imparts to the gas molecules a greater probability of egress than ingress with respect to the insulating space, thereby providing a deeper vacuum without requiring a getter material in the insulating space.

The construction of structures having gas molecule guiding geometry according to the present invention is not limited to any particular category of materials. Suitable materials for forming structures incorporating insulating spaces according to the present invention include, for example, metals, ceramics, metalloids, or combinations thereof.

The convergence of the space provides guidance of molecules in the following manner. When the gas molecule concentration becomes sufficiently low during evacuation of the space such that structure geometry becomes a first order effect, the converging walls of the variable distance portion of the space channel gas molecules in the space toward the vent. The geometry of the converging wall portion of the vacuum space functions like a check valve or diode because the probability that a gas molecule will leave the space, rather than enter, is greatly increased.

The effect that the molecule-guiding geometry of structure has on the relative probabilities of molecule egress versus entry can be understood by analogizing the converging-wall portion of the vacuum space to a funnel that is confronting a flow of particles. Depending on the orientation of the funnel with respect to the particle flow, the number of particles passing through the funnel would vary greatly. It is clear that a greater number of particles will pass through the funnel when the funnel is oriented such that the particle flow first contacts the converging surfaces of the funnel inlet rather than the funnel outlet.

Various examples of devices incorporating a converging wall exit geometry for an insulating space to guide gas particles from the space like a funnel are provided herein. It should be understood that the gas guiding geometry of the invention is not limited to a converging-wall funneling construction and can, instead, utilize other forms of gas molecule guiding geometries.

The outer wall can be generally U-shaped. The outer wall can have a flat bottom, but can also have a bottom portion (i.e., the bottom of the “U”) that is convex or concave. Similarly, the inner wall can be generally U-shaped, and can have a flat bottom, but can also have a bottom portion (i.e., the bottom of the “U”) that is convex or concave. As shown in FIG. 1A, the inner wall can be disposed within the outer wall so as to form a double-walled “U” in cross-section.

The inner and outer walls can be configured such that they converge toward one another, e.g., as shown in the circled region in FIG. 1A. One or both of the inner and outer walls can be made from stainless steel or other metals and/or metal alloys.

The kink portion of the outer wall can extend from the outer wall toward the inner wall. The kink portion can connect the outer wall to the joint portion of the outer wall. As shown in FIG. 1B, the joint portion can lie along/against the inner wall. The joint portion of the outer wall can be parallel to the outer wall, though this is not a requirement.

The joint portion can also be press-fit against the hook portion of the inner wall so as to maintain an intimate contact between the joint portion and the hook portion at an overlap region. In some embodiments, the hook portion of the inner wall, the joint portion of the outer wall, or both can be formed such that when assembled, one or both of the hook portion and the joint portion spring against the other. The hook portion of the inner wall can be connected to the inner wall by way of a curved portion of the inner wall, which curved portion can be U-shaped in configuration.

Embodiment 46. The container of embodiment 45, wherein the sealed space comprises a vacuum.

Embodiment 47. The container of embodiment 46, wherein the vacuum is at a pressure of from about 10⁻⁴ to about 10⁻⁷ Torr.

Embodiment 48. The container of any of embodiments 45-47, wherein the kink portion extends toward the inner wall by a distance about equal to a thickness of the hook portion of the inner wall.

A non-limiting illustration of this is provided in FIG. 5B. The kink portion of the outer wall can extend inward toward the inner wall and connect to the joint portion of the outer wall so as to provide a zig-zag profile (in cutaway view) of the outer wall. The kink portion and joint portion can be configured such that the joint portion of the outer wall is parallel to the outer wall; i.e., the kink portion acts as a bridge between the two parallel portions of the outer wall. The joint portion of the inner wall can have the same thickness as the lower wall, but can also be thicker or thinner than the lower wall. As shown in FIG. 5B, the kink portion of the outer wall can engage with the hook portion of the inner wall so as to give rise to a flush joint, and a smooth outer surface to the vessel.

Embodiment 49. The container of any of embodiments 45-48, wherein the joint portion of the outer wall extends at an angle of within about 20 degrees from an angle of the outer wall.

Embodiment 50. The container of embodiment 49, wherein the joint portion of the outer wall extends at an angle of within about 10 degrees from an angle of the outer wall.

Embodiment 51. The container of any of embodiments 45-50, wherein the inner and outer walls are characterized as converging toward one another at a union between the inner and outer walls.

Embodiment 52. The container of any of embodiments 45-51, wherein the hook portion of the inner wall is sealably joined to the kink portion of the outer wall by way of a brazed joint. It should be understood that the hook portion of the inner wall can be sealably joined to the kink portion of the outer wall by other methods besides brazing.

Embodiment 53. The container of any of embodiments 45-52, wherein the joint portion of the outer wall is sealably joined to the hook portion of the inner wall by way of a brazed joint. It should be understood that the joint portion of the outer wall can be sealably joined to the hook portion of the inner wall by other methods besides brazing.

Embodiment 54. The container of any of embodiments 45-53, wherein the hook portion of the inner wall is sealably joined to the kink portion of the outer wall by way of a brazed joint and wherein the joint portion of the outer wall is sealably joined to the hook portion of the inner wall by way of a brazed joint.

Embodiment 55. A vacuum-sealed container, comprising:

a circumferentially-extending, substantially U-shaped outer wall;

a circumferentially-extending, substantially U-shaped inner wall, the inner wall and outer wall defining a sealed space therebetween;

the outer wall including a kink portion, the kink portion extending toward the inner wall and the kink portion connecting the outer wall to a joint portion of the outer wall,

the joint portion of the outer wall overlapping the inner wall, a hook portion of the inner wall being connected to the inner wall by a curved portion of the inner wall, and

(a) the hook portion of the inner wall being sealably joined to the kink portion of the outer wall,

(b) the joint portion of the outer wall being sealably joined to the inner wall, or

both (a) and (b).

Embodiment 56. The container of embodiment 55, wherein the sealed space comprises a vacuum.

Embodiment 57. The container of embodiment 56, wherein the vacuum is at a pressure of from about 10⁻⁴ to about 10⁻⁷ Torr.

Embodiment 58. The container of any of embodiments 55-57, wherein the kink portion extends toward the inner wall by a distance greater than a thickness of the hook portion of the inner wall.

Embodiment 59. The container of any of embodiments 55-58, wherein the joint portion of the outer wall extends at an angle of within about 20 degrees from an angle of the inner wall.

Embodiment 60. The container of embodiment 59, wherein the joint portion of the outer wall extends at an angle of within about 10 degrees from an angle of the inner wall.

Embodiment 61. The container of any of embodiments 55-60, wherein the inner and outer walls are characterized as converging toward one another at a union between the inner and outer walls.

Embodiment 62. The container of any of embodiments 55-61, wherein the hook portion of the inner wall is sealably joined to the kink portion of the outer wall by way of a brazed joint.

Embodiment 63. The container of any of embodiments 55-62, wherein the joint portion of the outer wall is sealably joined to the hook portion of the inner wall by way of a brazed joint.

Embodiment 64. The container of any of embodiments 55-63, wherein the hook portion of the inner wall is sealably joined to the kink portion of the outer wall by way of a brazed joint and wherein the joint portion of the outer wall is sealably joined to the hook portion of the inner wall by way of a brazed joint.

Embodiment 65. A vacuum-insulated article, comprising: an outer tube having a proximal end and a distal end; an inner tube having a proximal end, a distal end, and a lumen, the inner tube being disposed within the outer tube and the inner tube having a major axis of the lumen of the inner tube, the inner tube and the outer tube being defining an evacuated insulating space therebetween, the evacuated insulating space having a proximal seal and a distal seal, (a) the proximal seal optionally being formed by a proximal vent formed between the outer tube and the inner tube, (i) the proximal vent being formed at an outflared region of the inner tube or (ii) the proximal vent being formed at a converging region of the inner tube, (b) the distal seal optionally being formed by a distal vent formed between the outer tube and the inner tube, (i) the distal vent being formed at an outflared region of the inner tube or (ii) the distal vent being formed at a converging region of the inner tube, and the proximal vent being located at a proximal vent radial distance from the major axis of the lumen, the distal vent being located at a distal vent radial distance from the major axis of the lumen, the proximal vent radial distance differing from the distal vent radial distance.

Embodiment 66. The vacuum-insulated article of Embodiment 65, wherein the proximal vent radial distance differs from the distal vent radial distance by less than 10% of the distal vent radial distance.

Embodiment 67. The vacuum-insulated article of Embodiment 65, wherein the proximal vent radial distance differs from the distal vent radial distance by from about 1 to about 99% of the distal vent radial distance.

Embodiment 68. The vacuum-insulated article of Embodiment 67, wherein the proximal vent radial distance differs from the distal vent radial distance by from about 20 to about 80% of the distal vent radial distance.

Embodiment 69. The vacuum-insulated article of Embodiment 68, wherein the proximal vent radial distance differs from the distal vent radial distance by from about 30 to about 70% of the distal vent radial distance.

Embodiment 70. The vacuum-insulated article of Embodiment 65, wherein the proximal vent radial distance differs from the distal vent radial distance by from about 1 to about 20% of the distal vent radial distance.

Embodiment 71. A vacuum-insulated article, comprising: an outer tube having a proximal end and a distal end; an inner tube having a proximal end, a distal end, and a lumen, the inner tube being disposed within the outer tube and the inner tube having a major axis of the lumen of the inner tube, the inner tube and the outer tube being defining an evacuated insulating space therebetween, the evacuated insulating space having a proximal seal and a distal seal, (a) the proximal seal being formed by a proximal vent formed between the outer tube and the inner tube, (b) the distal seal being formed by a distal vent formed between the outer tube and the inner tube, the proximal vent being located at a proximal vent radial distance from the major axis of the lumen, the distal vent being located at a distal vent radial distance from the major axis of the lumen, the proximal vent radial distance differing from the distal vent radial distance.

In some embodiments, the inner tube can flare outward toward the outer tube at one or more locations. In one embodiment, the inner tube can flare outwards at a first location by a first distance and flare outwards at a second location by a second distance, and the inner tube and outer tube can be sealed to one another by way of a proximal seal (e.g., at the first outwards flare) and a distal seal (e.g., at the second outwards flare). The first and second distances can be the same, but can differ. By having different first and second distances, an article can have (proximal and distal) seals that are located at different radial distances from the major axis of the lumen of the inner tube. The outer tube can converge inwardly toward the inner tube at one or more locations, which one or more locations can serve as the locations of one or more seals between the inner and outer tubes. As an example, a proximal seal can be formed where the inner tube flares outwardly toward the outer tube at a location where the outer tube does not converge inwardly toward the inner tube, and a distal seal can be formed where the inner tube flares outwardly toward the outer tube and the outer tube also flares inwardly toward the inner tube. In this way, the proximal and distal seals are located at different radial distances from the major axis of the lumen of the inner tube. As explained herein, seals between the inner and outer tubes can be located at different radial distances from the major axis of the lumen of the inner tube. The radial distance of a given seal can be defined by, e.g., an outward flare of the inner tube, an inward flare of the outer tube, an outward flare of the outer tube, and any combination thereof.

It should be understood that an article according to any of Embodiments 65-71 can also include any features recited in any of Embodiments 1-64.

1. A vacuum-insulated article, comprising:
an outer tube having a proximal end and a distal end; and
an inner tube having a proximal end, a distal end, and a lumen,
the inner tube being disposed within the outer tube and the inner tube having a major axis of the lumen of the inner tube,
the inner tube and the outer tube defining an evacuated insulating space therebetween,
the inner tube comprising a outflared region having an increasing diameter along the direction of the proximal end of the inner tube, the ouflared region extending toward the proximal end of the inner tube,
at least a portion of the outflared region extending beyond the proximal end of the outer tube, as measured along the major axis,
the proximal end of the inner tube extending beyond the proximal end of the outer tube, as measured along the major axis,
the outer tube comprising a tapered region having a decreasing diameter in the direction of the proximal end of the outer tube,
the outer tube comprising a proximal joint region extending from the tapered region of the outer tube in the direction of the proximal end of the outer tube,
the proximal joint region of the outer tube overlapping a portion of the inner tube.

2. The article of claim 1, wherein:
the inner tube comprises an outtapered region having an increasing diameter along the direction of the distal end of the inner tube,
the inner tube comprises a distal joint region extending from the outtapered region in the direction of the distal end of the inner tube,
the inner tube comprises an end flare region extending from the joint region in the direction of the distal end of the inner tube, the end flare region having an increasing diameter along the direction of the distal end of the inner tube,
at least a portion of the endflared region of the inner tube extending beyond the distal end of the outer tube, as measured along the major axis, and the distal end of the inner tube extending beyond the distal end of the outer tube, as measured along the major axis.

3. The article of claim 1, further comprising an amount of a braze material disposed between the proximal joint region of the outer tube and the inner tube.

4. The article of claim 1, further comprising an amount of a braze material disposed between the distal joint region of the inner tube and the outer tube.

5. The article of claim 1, wherein the outflared region of the inner tube and the proximal end of the outer tube define a proximal end trough.

6. The article of claim 5, further comprising an amount of a braze material disposed in the proximal end trough.

7. The article of claim 1, wherein the endflared region of the inner tube and the distal end of the outer tube define a distal end trough.

8. The article of claim 7, further comprising an amount of braze material disposed in the distal end trough.

9. The article of claim 1, wherein the evacuated insulating space has a pressure of between about 10⁻⁴ Torr and 10⁻⁹ Torr.

10. (canceled)

11. The article of claim 1, wherein the proximal joint region of the outer tube is essentially parallel to the inner tube.

12. The article of claim 1, wherein the inner tube comprises one or more indentation reigons, wherein the outer tube comprises one or more indentation regions, or both.

13. The article of claim 12, wherein the inner tube comprises an indentation region that is in register with an indentation region of the outer tube.

14. The article of claim 12, wherein one or both of the inner and outer tubes comprises two or more indentation regions.

15. (canceled)

16. A method, comprising:
with
(a) an inner tube comprising a proximal end, a distal end, a major axis, and a lumen,
the inner tube further comprising a outflared region having an increasing diameter along the direction of the proximal end of the inner tube, the outflared region extending toward the proximal end of the inner tube, and
(b) an outer tube comprising a proximal end and a distal end,
the outer tube further comprising a tapered region having a decreasing diameter in the direction of the proximal end of the outer tube,
the outer tube comprising a proximal joint region extending from the tapered region of the outer tube in the direction of the proximal end of the outer tube,
assembling the inner and outer tube so as to dispose the inner tube within the outer tube such that
at least a portion of the outflared region of the inner tube extends beyond the proximal end of the outer tube, as measured along the major axis,
the proximal end of the inner tube extends beyond the proximal end of the outer tube, as measured along the major axis, and
the proximal joint region of the outer tube overlaps at least a portion of the inner tube.

17. The method of claim 16, further comprising sealing the proximal joint region of the outer tube to the inner tube so as to define a sealed space between the inner tube and the outer tube.

18. (canceled)

19. The method of claim 18, wherein the sealed space defines a pressure of from about 10⁻⁴ Torr to about 10⁻⁹ Torr.

20. (canceled)

21. The method of claim 16, wherein
the inner tube comprises an outtapered region having an increasing diameter along the direction of the distal end of the inner tube,
the inner tube comprises a distal joint region extending from the outtapered region in the direction of the distal end of the inner tube,
the inner tube comprises an end flare region extending from the joint region in the direction of the distal end of the inner tube, the end flare region having an increasing diameter along the direction of the distal end of the inner tube,
and the inner and outer tubes are assembled such that at least a portion of the endflared region of the inner tube extends beyond the distal end of the outer tube, as measured along the major axis, and
the distal end of the inner tube extends beyond the distal end of the outer tube, as measured along the major axis.

22. The method of claim 21, further comprising sealing the distal joint region of the inner tube to the outer tube.

23. The method of claim 22, wherein the sealing is effected by brazing.

24. The method of claim 16, wherein one or both of the inner tube and outer tube comprises one or more indentation regions.

25. A vacuum-insulated article, comprising:
an outer tube having a proximal end and a distal end;
an inner tube having a proximal end, a distal end, and a lumen,
the inner tube being disposed within the outer tube and the inner tube having a major axis of the lumen of the inner tube,
the inner tube and the outer tube being defining an evacuated insulating space therebetween, the evacuated insulating space having a proximal seal and a distal seal,
(a) the proximal seal optionally being formed by a proximal vent formed between the outer tube and the inner tube, (i) the proximal vent being formed at an outflared region of the inner tube or (ii) the proximal vent being formed at a converging region of the inner tube,
(b) the distal seal optionally being formed by a distal vent formed between the outer tube and the inner tube, (i) the distal vent being formed at an outflared region of the inner tube or (ii) the distal vent being formed at a converging region of the inner tube, and
the proximal vent being located at a proximal vent radial distance from the major axis of the lumen,
the distal vent being located at a distal vent radial distance from the major axis of the lumen,
the proximal vent radial distance differing from the distal vent radial distance.

26. The vacuum-insulated article of claim 25, wherein the proximal vent radial distance differs from the distal vent radial distance by less than 10% of the distal vent radial distance.

27. The vacuum-insulated article of claim 25, wherein the proximal vent radial distance differs from the distal vent radial distance by from about 1 to about 99% of the distal vent radial distance.

28. The vacuum-insulated article of claim 27, wherein the proximal vent radial distance differs from the distal vent radial distance by from about 20 to about 80% of the distal vent radial distance.

29. The vacuum-insulated article of claim 28, wherein the proximal vent radial distance differs from the distal vent radial distance by from about 30 to about 70% of the distal vent radial distance.

30. The vacuum-insulated article of claim 25, wherein the proximal vent radial distance differs from the distal vent radial distance by from about 1 to about 20% of the distal vent radial distance.

31. A vacuum-insulated article, comprising:
an outer tube having a proximal end and a distal end;
an inner tube having a proximal end, a distal end, and a lumen,
the inner tube being disposed within the outer tube and the inner tube having a major axis of the lumen of the inner tube,
the inner tube and the outer tube being defining an evacuated insulating space therebetween, the evacuated insulating space having a proximal seal and a distal seal,
(a) the proximal seal being formed by a proximal vent formed between the outer tube and the inner tube,
(b) the distal seal being formed by a distal vent formed between the outer tube and the inner tube,
the proximal vent being located at a proximal vent radial distance from the major axis of the lumen,
the distal vent being located at a distal vent radial distance from the major axis of the lumen,
the proximal vent radial distance differing from the distal vent radial distance.
